(19) United States
(12) Patent Application Publication
(10) Pub. No.: US 2021/0011151 A1
(43) Pub. Date: Jan. 14, 2021

(54) RADAR RANGE AMBIGUITY RESOLUTION USING MULTI-RATE SAMPLING

(71) Applicant: GM GLOBAL TECHNOLOGY OPERATIONS LLC, Detroit, MI (US)

(72) Inventors: Oren Longman, Tel Aviv (IL); Igal Bilik, Rehovot (IL)

(73) Assignee: GM GLOBAL TECHNOLOGY OPERATIONS LLC, Detroit, MI (US)

(21) Appl. No.: 16/507,603

(22) Filed: Jul. 10, 2019

(51) Int. Cl. G01S 13/93; G01S 7/03

(52) U.S. Cl. CPC G01S 13/931; G01S 7/03; G01S 2013/9342; G01S 2013/9321; G01S 2013/9346; G01S 2013/9314

(57) ABSTRACT

A radar circuit for use with a vehicle or other host system includes a radio frequency (RF) signal generator, an RF antenna connected to the signal generator configured to transmit an RF waveform toward a radar target and receive a radar return signature reflected therefrom, and an analog-to-digital converter (ADC) in communication with the antenna and having a different sampling frequencies. The ADC may have multiple channels outputting sampled radar return signature data at the different sampling frequencies. An ECU is in communication with the ADC to receive the sampled radar return signature data from the ADC, generate a set of range hypotheses describing a possible range from the host system to the radar target, select a correct range hypothesis, and execute a control action using the correct range hypothesis. The correct range hypothesis corresponds to a true range to the radar target.

### INTRODUCTION

Radar systems are often employed to assist in the real-time detection and localization of obstacles in proximity to a host system. For example, a radar system may be used aboard a vehicle to detect other vehicles, pedestrians, or stationary objects. Radar is also an enabling technology for autonomous or semi-autonomous control of various driver-assist subsystems. Examples of such driver-assist subsystems include adaptive cruise control, automatic lane-changing/lane-keeping, automatic braking or steering, and backup assistance subsystems. Radar-based obstacle detection is also used to enhance overall situational awareness of a vehicle operator, e.g., by triggering and displaying timely alerts.

In a typical radar system, pulsed or continuous-wave (CW) radio frequency (RF) energy is transmitted as radio waves in a predetermined scanning direction, such as a forward, lateral, and/or rear direction relative to a host system. If the transmitted RF energy encounters a sufficiently reflective object as the waveform propagates through free space, some of the transmitted energy is reflected back toward the host system, whereupon the reflected energy is received by one or more antennas. The corresponding radar return signature is processed using onboard signal processing hardware and software. In this manner, the radar system is able to quickly ascertain the direction (i.e., azimuth and elevation) and a corresponding range to a detected radar target.

A radar system circuit ordinarily includes one or more antennas connected to an RF signal generator, with the antenna(s) radiating energy pulses from the RF signal generator into free space in a desired direction of propagation. The same or a different set of antennas receive some of the energy as a radar return signal when the transmitted energy is reflected from an obstacle located in the path of the energy pulses. As the return energy is typically much lower than the transmitted radar energy, the return signal is typically amplified. An amplified and demodulated return signal is then converted to a digital signal using an analog-to-digital converter (ADC). For CW radars, a given radar system has a specified maximum detection range that is limited by the sampling frequency of the ADC.

### SUMMARY

Disclosed herein is an improved radar circuit for use with a host system, e.g., a motor vehicle or other vehicle or mobile platform having a driver-assist system. The term “driver” as used herein may encompass human or robotic operators, and therefore the present teachings may be extended to semi-autonomous and autonomous vehicle applications. The term “assist” may include torque, braking, steering, and/or other assistance that is automatically provided as needed by an associated electronic control unit (ECU) in order to change the present operating state of the host system, and may also or alternatively include activation of audible, visible, and/or tactile warnings.

The radar circuit uses an ADC with multiple different sampling frequencies to estimate a true range to a radar target. As will be appreciated by one of ordinary skill in the art, the maximum detection range of a CW radar circuit increases with the sampling frequency of the ADC. However, a high-frequency ADC has certain potential disadvantages, including added complexity and cost, higher power demands, and the potential to generate more heat relative to lower-frequency ADCs. The multiple ADC sampling frequencies employed in accordance with the present teachings therefore provide an extended detection range comparable to a higher-frequency ADC while maintaining the cost and complexity advantages of low-frequency ADC sampling.

An effect of using the disclosed multi-sampling rate solution is that a given radar target is “detected” multiple times, with only one of the detection events being the true target and the rest being “ghost” or “alias” targets. This in turn causes range ambiguity that must be resolved as part of the solution. Each of the possible ranges to the target is referred to a “range hypothesis”. In order to determine the true range, a radar echo/return signal is sampled at multiple different ADC sampling rates. The ECU is therefore configured with the disclosed logic to enable the ECU to select the objectively correct range hypothesis from among the multiple range hypotheses, and to thereby eliminate the above-noted radar range ambiguity. The ECU does this using coherent integration of the various range hypotheses in the manner set forth herein.

In a disclosed embodiment, a radar circuit for use with a host system includes an RF signal generator configured to generate a predetermined RF waveform, and an RF antenna connected to the RF signal generator. The RF antenna transmits the RF waveform toward a radar target and receives a radar return signature from the radar target. The radar circuit also includes an ADC in communication with the RF antenna, with the ADC having multiple sampling frequencies, such that the ADC is configured to output sampled radar return signature data at the multiple sampling frequencies. An electronic control unit (ECU) in communication with the ADC is configured to receive the sampled radar return signature data from the ADC, generate a set of range hypotheses describing a possible range from the host system to the radar target, select a correct range hypothesis from the set of range hypotheses as a true range to the radar target, and execute a control action with respect to the host system using the correct range hypothesis.

Each sampling frequency is a whole divisor of a cutoff frequency of the ADC, such that the cutoff frequency is a least common denominator of the multiple sampling frequencies.

The ECU may up-sample the sampled radar return signature data to thereby integrate the sampled radar return signature data from the multiple channels into coherent up-sampled data. For instance, the ECU may use a zero padding process to up-sample the sampled radar return signature data.

The ECU in some embodiments generates the set of range hypotheses by frequency-shifting and summing the coherent up-sampled data. In other embodiments, the ECU is configured to select the correct range hypothesis as a range hypothesis having the highest signal energy in the set of range hypotheses.

A method for detecting a radar target in a host system includes generating a predetermined RF waveform using an RF signal generator, transmitting the RF waveform from the host system toward a radar target via an RF antenna connected to the RF signal generator, and receiving, via the RF antenna, a radar return signature reflected from the radar target. The method also includes sampling the radar return signature via a multi-channel ADC in which each respective channel of the multi-channel ADC has a different sampling frequency. The method also includes outputting sampled radar return signature data from the ADC at the different sampling frequencies, and processing the radar return signatures using an electronic control unit (ECU).

Processing in this embodiment may include generating a set of range hypotheses, each range hypothesis of which describes a possible range from the RF antenna to the radar target, selecting a correct range hypothesis from the set of range hypotheses as a true range to the radar target, and executing a control action with respect to the host system using the correct range hypothesis.

A vehicle is also disclosed herein that includes a radar circuit connected to the vehicle body, with the radar circuit configured as set forth above, i.e., with the above-noted RF antenna connected to an RF signal generator, the ECU, and the ADC having a plurality of different sampling frequencies.

The above summary is not intended to represent every embodiment or every aspect of the present disclosure. Rather, the foregoing summary merely provides an exemplification of some of the novel aspects and features set forth herein. The above features and advantages, and other features and advantages of the present disclosure, will be readily apparent from the following detailed description of representative embodiments and modes for carrying out the present disclosure when taken in connection with the accompanying drawings and the appended claims.

### BRIEF DESCRIPTION OF THE DRAWINGS

FIG. 1 is a schematic illustration of an example host system in the form of a motor vehicle having a radar circuit configured as set forth herein.

FIG. 2 is a schematic circuit diagram of an exemplary radar circuit usable with the host system illustrated in FIG. 1.

FIG. 3 is a combined plot of frequency-versus-amplitude depicting an exemplary under-sampling effect using a representative pair of low-frequency analog-to-digital converters (ADCs) or channels thereof.

FIGS. 4 and 5 are logic flow diagrams describing an embodiment of the present method.

FIG. 6 is a schematic depiction of a representative target vehicle being sampled at different ADC sampling rates.

FIGS. 7 and 8 are plots of frequency-versus-amplitude depicting an input signal to the radar circuit of FIG. 2 and an up-sampled variation thereof, respectively.

FIGS. 9 and 10 are plots of frequency versus amplitude depicting a processed input signal after range hypothesis generation and for multiple target hypotheses, respectively.

FIGS. 11-13 are schematic depictions of an exemplary range-Doppler map for different stages of processing and different decimation factors.

FIG. 14 is a range plot of range-versus-signal power depicting two range hypotheses.

FIG. 15 is a plot of range-versus-signal power depicting a correct range hypothesis.

FIG. 16 is a plot of beam pattern coherency depicted in azimuth-versus-power, with power in decibels depicted on the vertical axis and azimuth in degrees depicted on the horizontal axis.

The present disclosure is susceptible to various modifications and alternative forms, and some representative embodiments have been shown by way of example in the drawings and will be described in detail herein. It should be understood, however, that the inventive aspects of this disclosure are not limited to the particular forms disclosed. Rather, the disclosure is to cover all modifications, equivalents, combinations, subcombinations, and alternatives falling within the spirit and scope of the disclosure as defined by the appended claims.

### DETAILED DESCRIPTION

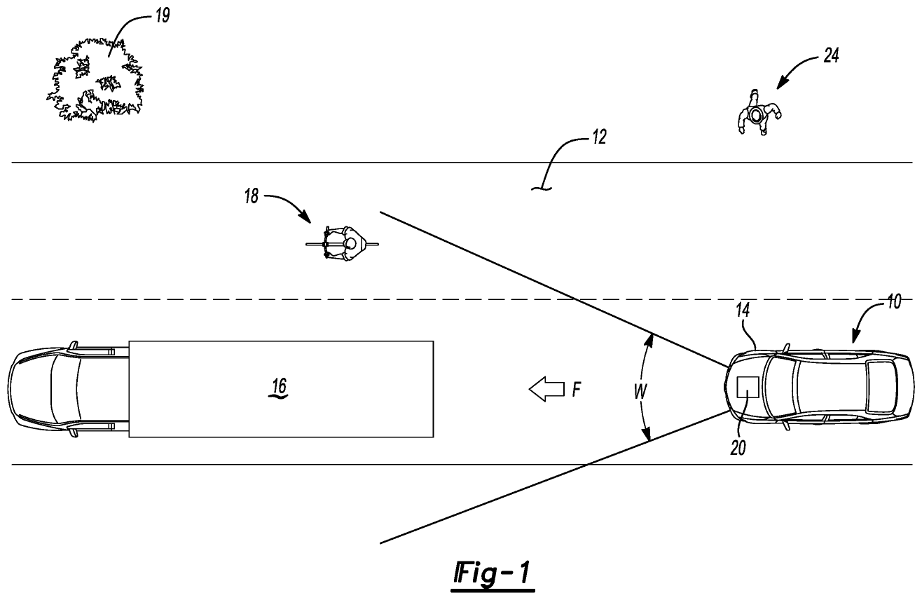

Referring to the drawings, wherein like reference numbers refer to like components, a host system in the form of an exemplary host vehicle 10 is depicted schematically in FIG. 1. The host vehicle 10 is depicted in the illustrated embodiment as a motor vehicle. However, other vehicles may benefit from the present teachings, including but not limited to watercraft, aircraft, and rail vehicles, with the teachings being applicable as well to robots and other mobile platforms. For illustrative consistency, the host vehicle 10 will be described hereinafter in the context of a ground-based vehicle without limiting the scope of the disclosure to such an embodiment.

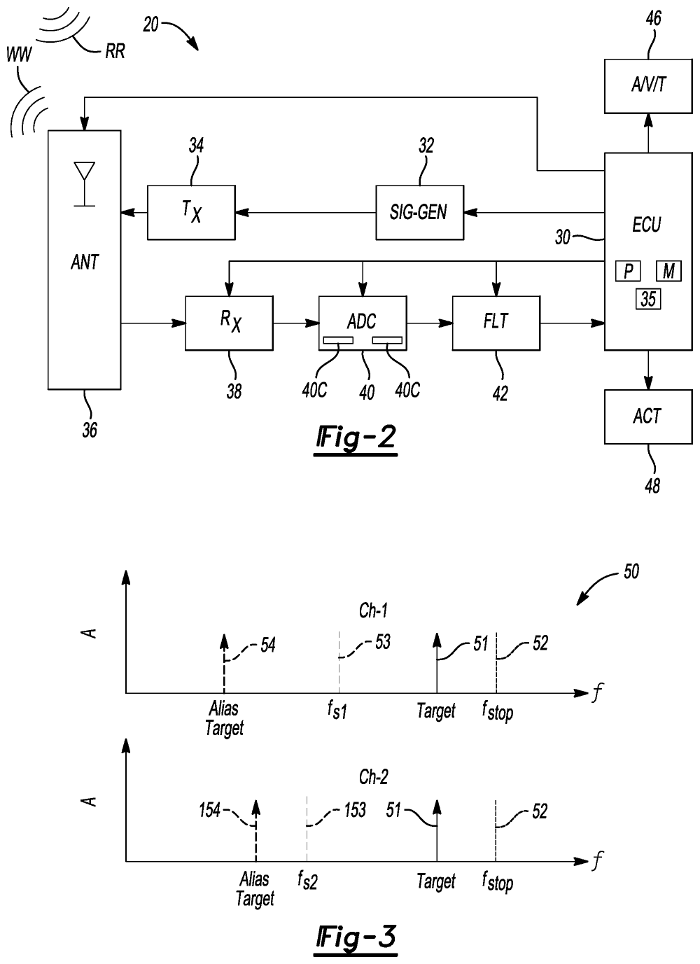

The host vehicle 10 includes a vehicle body 14 and a radar circuit 20, with an example embodiment of the radar circuit 20 being described in further detail below with reference to FIG. 2. The host vehicle 10, when optionally configured as a motor vehicle as shown, travels in the general direction of arrow F along a road surface 12. While traveling in such a direction, the host vehicle 10 may at times encounter static or dynamic obstacles. For instance, the host vehicle 10 may encounter relatively large vehicles such as a truck 16 or relatively small vehicles such as a motorcycle or bicycle 18. The host vehicle 10 may likewise encounter various stationary objects 19 such as trees or bushes as shown, or posts, signs, buildings, traffic barriers, or guard rails. Likewise, smaller static or dynamic obstacles such as pedestrians 24 or animals may be present in the general vicinity of the host vehicle 10, such as the depicted pedestrian 24 waiting to cross an intersection or walking on or alongside the road surface 12.

In order to more accurately detect the various possible radar targets shown in FIG. 1, the radar circuit 20 is configured to generate and transmit a radar beam of a beam width (W) in a predetermined direction with respect to the vehicle body 14, e.g., forward in the direction of travel (arrow F) as shown and/or in lateral or rearward positions depending on the operating mode and capabilities of the host vehicle 10. The radar circuit 20 may be variously configured to transmit the radar beam with an application-specific frequency, power, and maximum detection range. For instance, the radar circuit 20 may be configured to generate linear-frequency-modulated continuous-wave (LFM-CW) radar signals in certain embodiments, as will be appreciated by one of ordinary skill in the art.

Referring to FIG. 2, the radar circuit 20 includes an electronic control unit (ECU) 30 programmed with range ambiguity resolution logic 35 as described below. The ECU 30 may be an integral module of, or a separate module operatively connected to, other resident controllers of the host vehicle 10. The ECU 30 may be variously embodied as one or more digital computers including cores or processors (P), e.g., a microprocessor or central processing unit, as well as memory (M) in the form of read only memory, random access memory, electrically-programmable read only memory, etc. The ECU 30 may also include a high-speed clock, analog-to-digital and digital-to-analog circuitry, input/output circuitry and devices, and appropriate signal conditioning and buffering circuitry.

In a representative embodiment, hardware components of the radar circuit 20 may include an RF signal generator (“SIG-GEN”) block 32 configured to generate a predetermined RF waveform, an RF transmitter (“Tx”) 34, and one or more RF antennas (“ANT”) 36 connected to the RF signal generator block 32. The RF signal generator block 32 is configured to transmit the generated RF waveform (“WW”) away from the host vehicle 10 and toward prospective radar targets, and to receive a radar return signature or signal (“RR”) as energy reflected by the radar target(s). The ECU 30 is configured to control operation of the RF signal generator 32 to initiate an application-suitable radar beam, with the RF transmitter 34 ultimately producing pulses of an application-specific RF energy responsive to output signals from the RF signal generator 32. Such energy pulses are radiated into free space in a desired direction of propagation by the RF antenna 36. Upon reflection from an obstacle (potential radar target), the radar return signals are detected as the above-noted return signature by the RF antenna 36, and thereafter possibly amplified and demodulated via an RF receiver (“Rx”) 38. The radar return signature data, which is in analog form at this point, is received by an analog-to-digital converter (ADC) 40 and converted to a corresponding digital signal by the ADC 40, which as depicted may include multiple channels 40C each with a different respective ADC sampling frequency. While depicted as two channels 40C of a single ADC 40 for simplicity, multiple ADCs 40 could be used in the alternative, with each ADC 40 having a corresponding sampling frequency.

The digital output of the ADC 40 may be filtered via a filtering block (“FLT”) 42, e.g., using a Doppler filter, low-pass filters, etc. The filtered digital signals are then fed into the ECU 30 for processing and, ultimately, for target detection. While not described herein, those of ordinary skill in the art will appreciate that radar target detection may be accomplished by various well-established techniques, such as using a constant false alarm rate (CFAR) detector and/or using threshold energy comparisons to detect a given target. The present logic 35 may be used in conjunction with such detection techniques to extend the detection range without requiring high-frequency ADC hardware.

The ECU 30 of FIG. 2 may selectively command the execution of control actions responsive to target detection. For instance, the ECU 30 may command the activation of an audio, visual, and/or tactile (“A/V/T”) device 46 to alert an operator of the host vehicle 10 as to the detected target(s). Example embodiments of the A/V/T device 46 include speakers, lights, and/or vibrating or pulsating seat or steering wheel surfaces. The ECU 30 may also transmit control signals to an actuator (“ACT”) 48. For instance, the actuator 48 may be a controlled portion of a driver assist subsystem such as but not limited to adaptive cruise control, automatic braking or steering assist, high-beam on/off state, lane-changing/lane-keeping, backup, parking, and/or towing assist, etc. Thus, the control actions governed by the ECU 30 may result in a change of dynamic and/or logical operating state of the host vehicle 10, e.g., via transmission of control signals to the actuator(s) 48 for the driver assist subsystem.

The range ambiguity resolution logic 35 of the present disclosure is described in detail below with reference to the remaining Figures. In general, a radar system such as the radar circuit 20 of FIGS. 1 and 2 has a limited unambiguous range. In an LCM-CW radar system, for example, the maximum detection range Rₘₐₓ may be specified as:

$${R}_{max} = \frac{{f}_{{stop}^{C}}}{α2}$$

where fₛₜₒₚ is the cutoff frequency of an anti-aliasing low-pass filter used as part of the radar circuit 20, a is the chirp slope, and c is the speed of light. To prevent signal aliasing, the cutoff frequency (fₛₜₒₚ) is usually set equal to the sampling frequency (fₛ) of the ADC, i.e., f ₛ=fₛₜₒₚ. In this manner, an ADC's sampling frequency is what determines the maximum detection range as a trade-off between signal resolution and a maximum unambiguous Doppler range:

$$Δ R = \frac{c}{2 α {T}_{c}}$$

$${D}_{max} = \frac{λ}{4 {T}_{c}}$$

where ΔR is the range resolution, T_{c} is the chirp duration, and λ is the signal wavelength.

Referring to the sample data 50 shown in FIG. 3, when determining a range to a radar target using a typical ADC setup in which multiple ADC channels process at the same ADC sampling frequency, anti-aliasing filters ensure that a given target is detected once, e.g., at 100 m. Thus, a sampled signal may appear as a target signal 51, with a cutoff frequency (fₛₜₒₚ) 52 being the same as the ADC sampling frequency (fₛ) as noted above. In contrast, the present approach detects beyond the ADC sampling frequency (fₛ) to extend the maximum unambiguous detection range, e.g., out to 200 m or beyond. This occurs by extending the cutoff frequency (fₛₜₒₚ) 52 beyond the different sampling frequencies 53 and 153 (fₛ₁ and fₛ₂) of the two ADC channels (“Ch-1” and “Ch-2”). Under-sampling results in signal aliasing, however. Alias target signals 54 and 154 are therefore depicted in FIG. 3 for the respective ADC channels.

The problem of aliasing is solved as set forth herein by simultaneously sampling the received return signals at multiple different sampling frequencies, e.g., by programming the ADC 40 of FIG. 1 with channels having a corresponding sampling rate, e.g., 3.32 MHz and 2.37 MHz as a non-limiting illustrative example, or having multiple ADCs 40 each with a corresponding sampling frequency. Such a sampling scheme generates multiple target hypotheses for each sampling rate, as noted above and explained in further detail below. A “correct” range to a given radar target is then estimated by choosing a range hypothesis that best matches most of the different range hypotheses, as set forth herein.

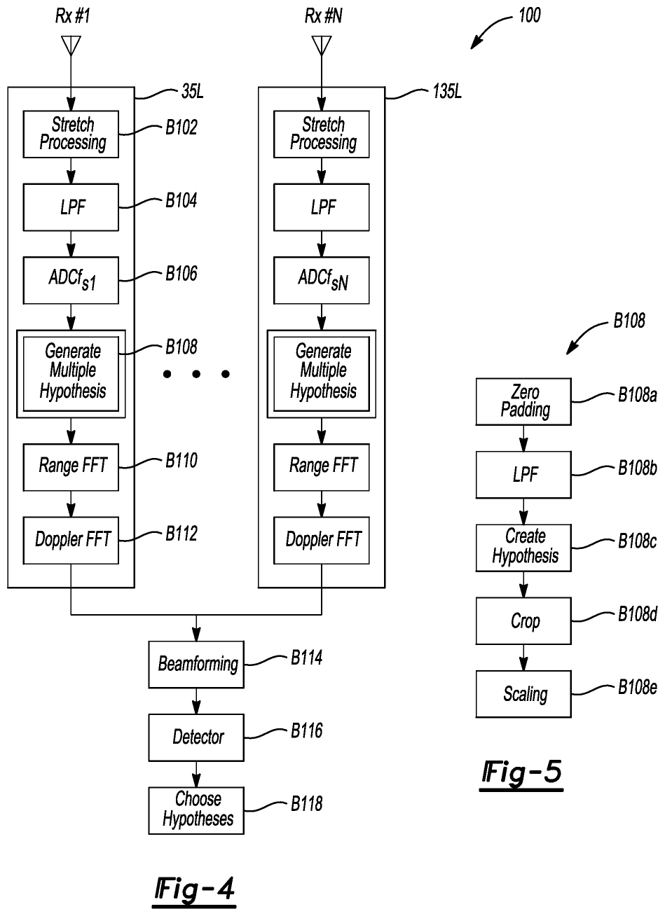

FIG. 4 depicts an example embodiment of the present method 100 using multiple ADC channels (Rx #1, . . . Rx #N), which may be programmed as part of a single ADC 40 or embodied as multiple ADCs 40, with the multiple represented as “N”. Each channel has corresponding logic 35L and 135L. In a simplified embodiment, N=2, however additional ADCs 40 or channels may be used in other embodiments.

In general, the method 100 for detecting a radar target in a host system, e.g., the host vehicle 10 of FIG. 1, includes generating the predetermined RF waveform (WW) using the RF signal generator block 32 of FIG. 2, then transmitting the RF waveform from the host system/vehicle 10 toward the radar target via the RF antenna. The method 100 includes receiving, via the RF antenna, a radar return signature reflected from the radar target, and then sampling the radar return signature via the ADC 40, with each respective channel of the ADC 40 having a different sampling frequency.

The method 100 additionally includes outputting sampled radar return signature data from the ADC 40 at the different sampling frequencies, and then processing the radar return signatures using the ECU 30. As detailed below, processing via the ECU 30 includes generating a set of range hypotheses, with each range hypothesis describing a possible range from the RF antenna block 36 to the radar target, selecting a correct range hypothesis from the set of range hypotheses as a true range to the radar target, and executing a control action with respect to the host system/vehicle 10 using the correct range hypothesis.

A particular embodiment of such a method 100 begins with block B102. The ECU 30 of FIG. 2 may perform stretch processing or “de-chirp” of the received (analog) radar return signals, as those terms are understood in the art, which are then processed via a low-pass filter (LPF) block B104. At block B104, the cutoff frequency (fₛₜₒₚ) of the LPF at block B104 is extended to support the extended maximum range (Rₘₐₓ) contemplated herein, i.e.,:

$${R}_{max} = \frac{{f}_{stop} c}{α 2}$$

as described above. The method 100 then proceeds to block B106.

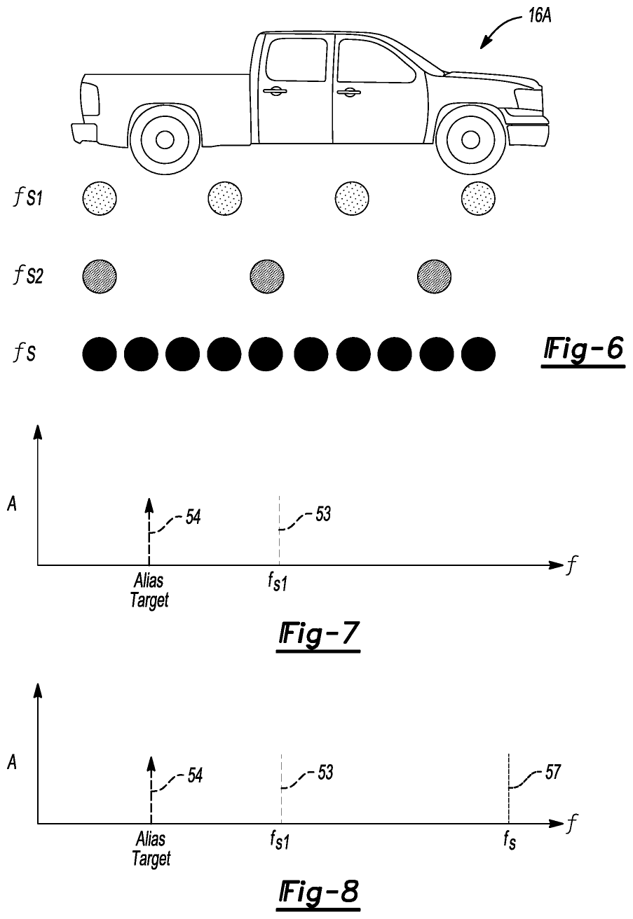

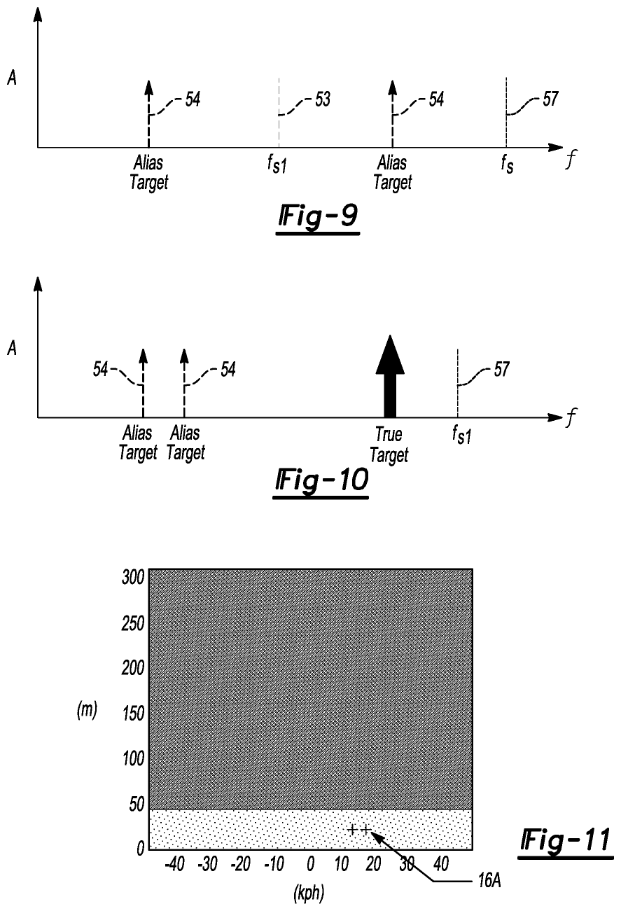

Block B106 entails performing an analog-to-digital conversion using the corresponding ADC 40 or channels thereof, e.g., ADCfₛ₁, . . . ADCf_{sN}. Referring briefly to FIGS. 6-8, as noted above the sampling rates of the various ADCs 40/channels are different. When detecting a representative target vehicle 16A (FIG. 6) using two channels, for instance, two different sampling frequencies fₛ₁ and fs2 are used in lieu of a high sampling frequency (fₛ). FIG. 7 depicts the received input signal data for the ADC channel corresponding to the sampling frequency 53 (Ts), with an alias target 54 also depicted. FIG. 8 shows the same signal after up-sampling has been completed. FIG. 9, by comparison, depicts the processed signal after hypothesis generation, i.e., block B108 of FIG. 4 as further described below with reference to FIG. 5. Note the presence of multiple alias targets 54. The second channel with sampling frequency fₛ₂ behaves in a similar manner, and is therefore not depicted in FIGS. 6-9.

Referring again to FIG. 4, implementation of block B106 ensures that the sampling frequencies are sufficiently different from each other, e.g., 2.37 MHz and 3.32 MHz according to a non-limiting illustrative example. The sampling frequencies are whole divisors of the cutoff frequency, fₛₜₒₚ, such that the cutoff frequency is the lowest common denominator. For example, sampling frequencies of 3 MHz and 5 MHz could be used for a cutoff frequency of 15 MHz. As part of block B106, the channels of an ADC 40 may be divided into multiple groups, e.g., two groups of four, with each group having a corresponding sampling frequency. Larger divisors would enable extension of the maximum detection range, but at the cost of a lower signal-to-noise ratio, an increase in the probability of selecting “ghost targets”, and target masking potentially leading to a higher rate of undetected radar targets. Thus, block B106 involves making an application-specific performance tradeoff. The method 100 proceeds to block B108 once block B106 has been completed.

At block B108, which is depicted in a greater level of detail in FIG. 5, the ECU 30 of FIG. 2 generates multiple range hypotheses. Each ADC channel is sampled at a different sampling frequency, as noted above in block B106. The samples have different phase values and cannot be coherently integrated. This problem may be resolved by projecting the different samples into a joint sampling grid with a grid sampling rate of (fₛ). Projection from the base grid to the joint grid may be achieved by up-sampling the radar return signal.

For instance, a “zero padding” process may be used at sub-block B108a of FIG. 5 by adding zeros between samples, with the number of zeros being

$$\frac{{f}_{s}}{{f}_{sN}} - 1 .$$

A low-pass filter may be applied at sub-block B108b with a cutoff frequency of f_{sN} to filter out high-frequency arguments. Block B108 results in a signal, S(m), having only the trivial hypotheses in the frequency span of [0,f_{sN}].

Block B108 further includes sub-block B108c, which is used to create a set of range hypotheses. A signal which incorporates all possible range hypotheses may be generated by frequency-shifting and summing the up-sampled signal:

$${S}_{H} [ m ] = {\sum }_{i = 0}^{\frac{{f}_{s}}{{f}_{sN}} - 1} s [ m ] {e}^{2 π j \frac{m}{M} {f}_{s N}^{i}}$$

where m is the sample index, M is the number of samples, and j=\sqrt{−1}. At sub-block B108d of FIG. 5 the signal is then cropped. The signal length may not be a power of 2, i.e., 2^{L}, for an integer L. In this case, the signal is cropped to be a length equal to the power of 2. Sub-block B108e is then used to scale the result. ADC channels with higher sampling frequencies have increased target energy, as will be appreciated, and thus channel normalization may be required, e.g., by applying a channel normalization factor of

$$\frac{{f}_{s}}{{f}_{sN}} .$$

Referring again to FIG. 4, blocks B110 and B112 include performing range FFT and Doppler FFT on the output from block B108, as will be appreciated by those of ordinary skill in the art. The transformed signals from block B112 (from the various ADCs 40) are fed into blocks B114 and B116 where well-established beamforming and detection processes are then performed. That is, the proposed method 100 enforces signal coherency between the various channels of the ADC 40, which in turn enables operation of coherent beamforming. The correct or “true” radar target is coherently integrated with the various channels, with “ghost” targets partially integrated and filtered out by choosing the higher-energy hypotheses as described below.

At block B118 of FIG. 4, the ECU 30 next chooses the correct range hypothesis. Referring to FIG. 10, each detection event may be a false “ghost” or alias target 54, or the detection may correspond to the true target 55. The true target 55 may be selected by the ECU 30 from among the various alias targets 54 by choosing the detection event having the highest signal energy among the possible hypotheses.

A hypothesis selection algorithm may be used to implement block B118. A non-limiting example embodiment of such an algorithm may be expressed as follows:

Algorithm 1 Hypothesis Selection

| | |
|---|---|
| Require: x | [symbol] Detections |
| Require: f | [symbol] Sampling Rates |
| Require: df | [symbol] Hypothesis Tolerances |
| I = length(x) | [symbol] Number of Detections |
| N = length(f) | [symbol] Number of Sampling Rates |

% Divide detections into hypothesis buckets

| | |
|---|---|
| for n = 1 : N do | [symbol] Loop on sampling rates |
| Span[n] = 0:df[n]:f[n] | |
| for i = 1 : I do | [symbol] Loop on Detections |
| Res =mod(x[i].frequency;f[n]); | |
| K = arg minₖ \|Res - Span[n, k]\| | |
| x[i].Bucket[n]=K | |
| Bucket[n,K].add(i) | |
| end for | |
| end for | |

```
  % Mark a detection as true if it has a higher energy than all
  detections it shares a buckets with
```

| | |
|---|---|
| for i = 1 : I do | [symbol] Loop on Detections |
| if x[i].Target == false then | |
| Continue | |
| end if | |
| Max = 0 | |
| for n = 1 : N do | [symbol] Loop on sampling rates |
| K=x[i].Bucket[n] | |

Max = max(Max,Bucket[n,K].Detections.Energy)

```
    end for
    if x[i].Energy > Max then
      x[i].Target = true
```

Bucket[n,K].Detections.Target = false

```
    else
      x[i].Target = false
    end if
end for
```

FIGS. 11-16 describe an illustrative example application of the present logic 35 in which a hypothetical baseline radar circuit operates at a 3.32 MHz with a maximum range of about 62 m. A radar target is present at a true range of 154 m from the host vehicle 10, with distance in meters (m) depicted on the vertical axis and speed in kilometers per hour (kph) depicted on the horizontal axis. Using the present teachings, the ADC 40 is divided into two different channels at sampling frequencies of 2.37 MHz and 3.32 MHz, with a cutoff frequency of 16.6 MHz (i.e., the lowest common denominator of the two exemplary ADC sample rates). As will be appreciated, a decimation process may be used to degrade a sample signal, with example decimation factors of (5) and (7) resulting in the indicated 3.32 MHz and 2.37 MHz and rates, respectively.

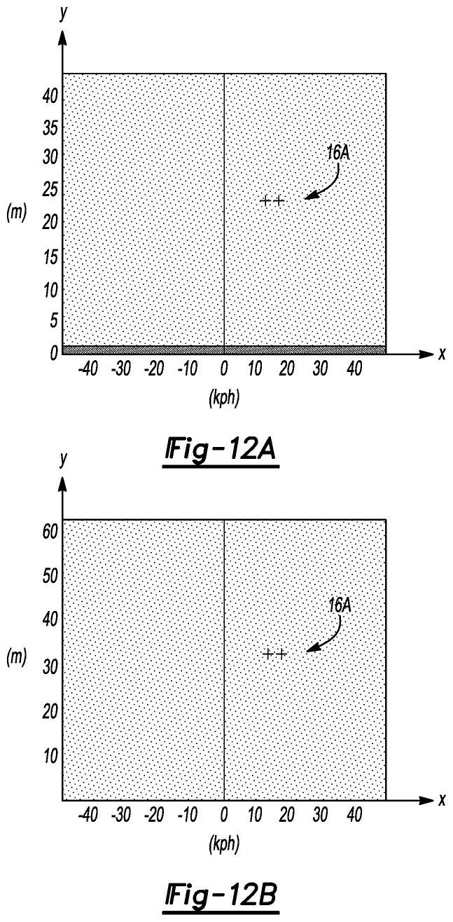

FIGS. 12A and 12B depict a simplified range Doppler map for a decimation factor of (7), i.e., 2.37 MHz, and (5), i.e., 3.32 MHz as noted above. The ambiguous target ranges are about 20.6 m (FIG. 12A) and about 30.4 m (FIG. 3B). As described above, various alias/ghost targets exist at different ranges to the target 16A for each ADC channel, as represented by the multiple “+” symbols. FIG. 11 depicts a range Doppler map of the same two detections of the target 16A after up-sampling has been completed in block B108 of FIG. 4, with FIG. 11 representing an extended maximum detection range of 310 m, which may be compared to the individual detection ranges of the two channels of FIGS. 12A and 12B, e.g., 44 m (FIG. 12A) and 62 m (FIG. 12B).

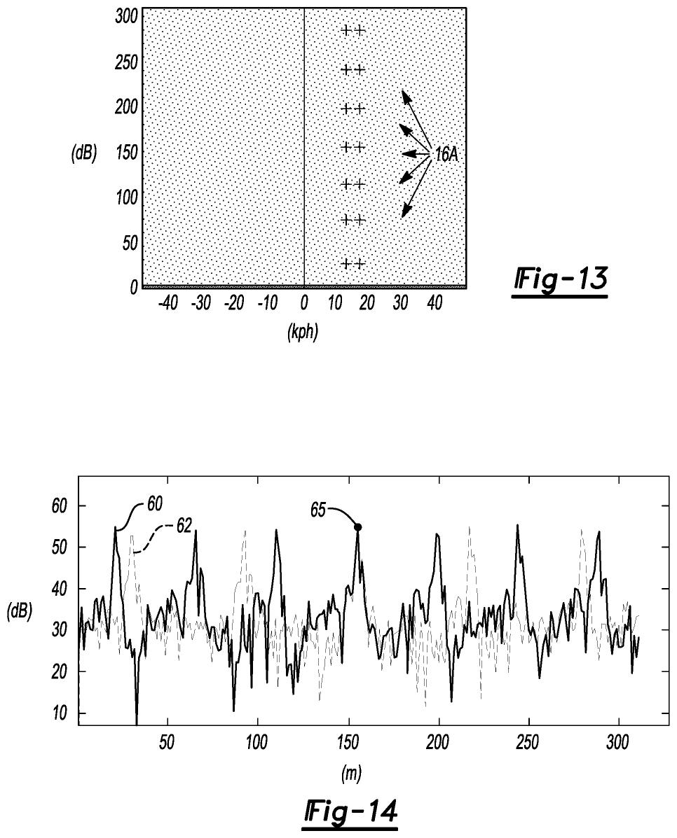

In FIG. 13, the return signal after up-sampling shows the representative target 16A located at various possible ranges anywhere between about 25 m to 280 m from the host vehicle 10. In FIG. 14, traces 60 and 62 show signal power in decibels (dB) versus the range to the target 16A in meters (m), with trace 60 corresponding to decimation factor (7), i.e., the channel scanning at 2.37 MHz in this example, and trace 62 corresponding to decimation factor (5), i.e., 3.32 MHz. A correct hypothesis exists where the two traces 60 and 62 coincide with maximum power, i.e., solution point 65 at a range of about 154 m.

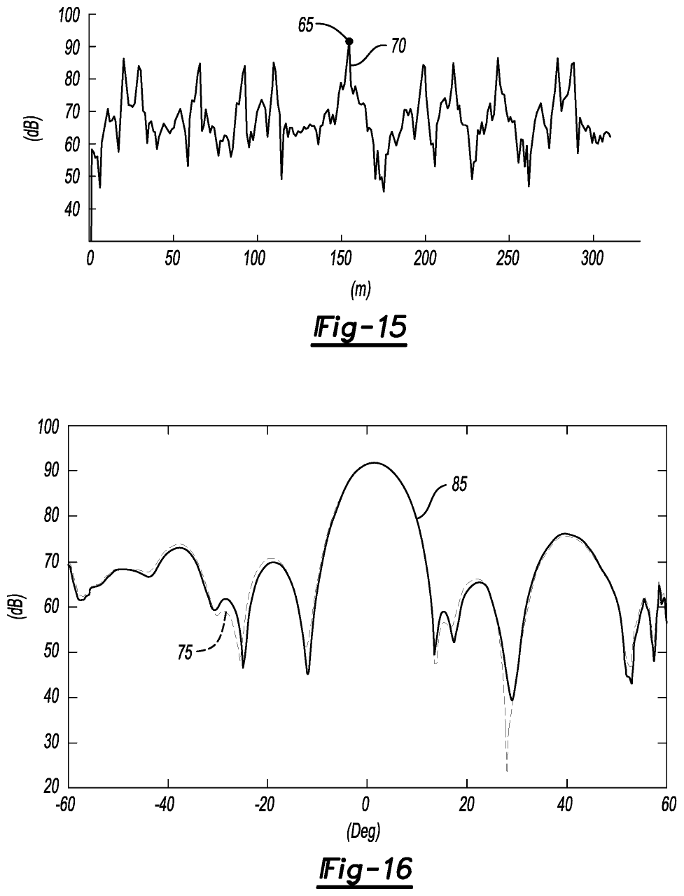

Referring to FIGS. 15, a trace 70 of the local maximums of the traces 60 and 62 depicted in FIG. 14 has a stronger signal power level, by a factor of about 6 dB in this example, which enables selection of the correct hypothesis. As a result, a smaller, lower cost ADC 40 running multiple channels at different sampling frequencies may be used to detect radar targets at extended ranges that would ordinarily require much higher sampling frequencies. For instance, the detection range is extended from 62 m to 300 m in the above example.

The present approach coherently integrates the various return signals when sampled at different rates. As shown in FIG. 16, an original beam pattern (trace 75) may be compared to a reconstructed beam pattern (trace 85) formed according to method 100. In terms of signal coherency, substantially all of the initial beam energy remains in the reconstructed beam pattern (trace 85). Thus, the correct hypothesis shown as solution point 65 in FIGS. 14 and 15 may be selected with a high degree of confidence. When used aboard the host vehicle 10 of FIG. 1, therefore, the results of the present method 100 may be used to execute a suitable control action, such as but not limited to activating an alert aboard the host vehicle 10 and/or changing the dynamic state of the host vehicle 10 via control of a driver assist subsystem.

While some of the best modes and other embodiments have been described in detail, various alternative designs and embodiments exist for practicing the present teachings defined in the appended claims. Those skilled in the art will recognize that modifications may be made to the disclosed embodiments without departing from the scope of the present disclosure. Moreover, the present concepts expressly include combinations and sub-combinations of the described elements and features. The detailed description and the drawings are supportive and descriptive of the present teachings, with the scope of the present teachings defined solely by the claims.

What is claimed is:

1. A radar circuit for use with a host system, the radar circuit comprising:
a radio frequency (RF) signal generator configured to generate a predetermined RF waveform;
an RF antenna connected to the RF signal generator, wherein the RF antenna is configured to transmit the RF waveform toward a radar target and receive a radar return signature from the radar target;
an analog-to-digital converter (ADC) in communication with the RF antenna wherein the ADC has multiple sampling frequencies, such that the ADC is configured to output sampled radar return signature data at the multiple sampling frequencies; and
an electronic control unit (ECU) in communication with the ADC, and configured to receive the sampled radar return signature data from the ADC, generate a set of range hypotheses describing a possible range from the host system to the radar target, select a correct range hypothesis from the set of range hypotheses as a true range to the radar target, and execute a control action with respect to the host system using the correct range hypothesis.

2. The radar circuit of claim 1, wherein each sampling frequency of the multiple sampling frequencies is a whole divisor of a cutoff frequency of the ADC, such that the cutoff frequency is a least common denominator of the multiple sampling frequencies.

3. The radar circuit of claim 1, wherein the ECU is configured to up-sample the sampled radar return signature data to thereby integrate the sampled radar return signature data from the multiple sampling frequencies into coherent up-sampled data.

4. The radar circuit of claim 3, wherein the ECU is configured to use a zero padding process to up-sample the sampled radar return signature data.

5. The radar circuit of claim 3, wherein the ECU is configured to generate the set of range hypotheses by frequency-shifting and summing the coherent up-sampled data.

6. The radar circuit of claim 1, wherein the ECU is configured to select the correct range hypothesis as a range hypothesis having the highest signal energy in the set of range hypotheses.

7. A method for detecting a radar target in a host system, the method comprising:
generating a predetermined radio frequency (RF) waveform using an RF signal generator;
transmitting the RF waveform from the host system toward a radar target via an RF antenna connected to the RF signal generator,;
receiving, via the RF antenna, a radar return signature reflected from the radar target;
sampling the radar return signature via a multi-channel analog-to-digital converter (ADC), wherein each respective channel of the multi-channel ADC has a different sampling frequency;
outputting sampled radar return signature data from the ADC at the different sampling frequencies; and
processing the radar return signatures using an electronic control unit (ECU), including:
generating a set of range hypotheses, each range hypothesis of which describes a possible range from the RF antenna to the radar target;
selecting a correct range hypothesis from the set of range hypotheses as a true range to the radar target; and
executing a control action with respect to the host system using the correct range hypothesis.

8. The method of claim 7, wherein the different sampling frequencies are whole divisors of a cutoff frequency of the ADC.

9. The method of claim 7, the method further comprising up-sampling the sampled radar return signature data to thereby integrate the sampled radar return signature data from the multi-channel ADC into coherent up-sampled data.

10. The method of claim 9, wherein up-sampling the sampled radar return signature data includes using a zero padding process.

11. The method of claim 9, wherein generating the set of range hypotheses includes frequency-shifting and summing the coherent up-sampled data.

12. The method of claim 7, wherein selecting the true range to the radar target includes selecting a hypothesis having a highest signal energy in the set of hypotheses.

13. The method of claim 7, wherein the host system is a vehicle, and wherein executing the control action aboard the host system includes activating an alert aboard the vehicle.

14. The method of claim 13, wherein the vehicle is a motor vehicle having a driver assist subsystem, and wherein executing the control action includes changing a dynamic state of the motor vehicle via transmission of control signals to the driver assist subsystem.

15. A vehicle comprising:
a vehicle body;
a driver assist subsystem; and
a radar circuit connected to the vehicle body, including:
a radio frequency (RF) signal generator configured to generate a predetermined RF waveform;
an RF antenna connected to the RF signal generator, wherein the RF antenna is configured to transmit the RF waveform toward a radar target and receive a radar return signature reflected from the radar target;
an analog-to-digital converter (ADC) in communication with the RF antenna and having a plurality of different sampling frequencies, wherein the ADC has multiple channels configured to output sampled radar return signature data at the different sampling frequencies; and
an electronic control unit (ECU) in communication with the ADC, and configured to receive the sampled radar return signature data from the ADC, generate a set of range hypotheses describing a possible range from the vehicle to the radar target, select a correct range hypothesis from the set of range hypotheses, and execute a control action with respect to the vehicle using the correct range hypothesis, wherein the correct range hypothesis corresponds to a true range to the radar target, and wherein the control action includes one or both of activating an alert aboard the vehicle and changing a dynamic state of the vehicle via transmission of control signals to the driver assist subsystem.

16. The vehicle claim 15, wherein the different sampling frequencies are whole divisors of a cutoff frequency of the ADC.

17. The vehicle of claim 15, wherein the ECU is configured to up-sample the sampled radar return signature data from the ADC to thereby integrate the sampled radar return signature data from the multiple channels into coherent up-sampled data.

18. The vehicle of claim 17, wherein the ECU is configured to use a zero padding process to up-sample the sampled radar return signature data.

19. The vehicle of claim 17, wherein the ECU is configured to generate the set of range hypotheses by frequency-shifting and summing the coherent up-sampled data.

20. The vehicle of claim 15, wherein the ECU is configured to select the true range to the radar target by selecting a hypothesis having a highest signal energy in the set of hypotheses.
